(19) United States
(12) Patent Application Publication
(10) Pub. No.: US 2004/0017548 A1
(43) Pub. Date: Jan. 29, 2004

(54) Digital media source integral with microprocessor, image projection device and audio components as a self-contained

(76) Inventor: Timothy J. Denmeade, Poland, OH (US)

Correspondence Address: Cohen & Grigsby, P.C., 15th Floor, 11 Stanwix street, Pittsburgh, PA, 15222, US

(21) Appl. No.: 10/388,157

(22) Filed: Mar. 13, 2003

Related U.S. Application Data
(60) Provisional application No. 60/363,919, filed on Mar. 13, 2002.

(51) Int. Cl. G03B 21/00

(52) U.S. Cl. 353/31

(57) ABSTRACT

A combination of a Digital Media Source, such as, a computer hard drive, digital disc player (DVD), and/or Compact Disc (CD) format, or other; integral with a microprocessor; an image projection device, such as, a LCD or DLP based projector; a set of controls; and audio components to provide a stand alone system for use as a toy projection system, business projection system, or home projection system. The system is enclosed in a housing that is configured to meet the market application. The image projection device can be rotated within the housing or via mirror(s) to project images on vertical and horizontal surfaces, such as, walls, screens, ceilings, and desktop rear projection screens. The system will be easy to operate, self-contained, portable and will be suitable for use by children and adults with minimal skill required.

### FIELD OF INVENTION

The present invention relates in general to a combination of a Digital Media Source (internal and/or external), such as, a computer hard drive, digital disc player using Digital Versatile/Video Disc (DVD), and/or Compact Disc (CD) format, and/or Compact Flash card, or any other non-volatile digital storage media and device; integrated with a Microprocessor; an Image Projection Device, such as, a Liquid Crystal Display (LCD) or Digital Light Processors (DLP) based projector; a set of controls (with optional remote control), and Audio Components to provide a stand alone system for use as a toy projection system, business projection system, or home projection system.

### BACKGROUND OF INVENTION AND PRIOR ART

Digital Projection Devices

Today, fixed installation and portable digital projectors are widely used in many business settings and to a less extent in some home theater applications. Despite aggressive competition and the presence of numerous manufacturers, digital projectors remain relatively expensive and are primarily purchased for and used in institutional settings.

Today, digital projectors are used as a projection device only taking data and video from a physically separate, independent source such as a videocassette recorder (VCR), computer (via portable laptop or dedicated office unit), camera, or other input device. Thus, current digital projectors are used as an exclusive unit for the function of projection only. Current projection technology must have input from a separate input device connected to the digital projector by purpose built connectors and cabling. Likewise, some digital projectors have speakers built in to provide audio capability but the audio signal must come from a separate independent input device transmitted through wires and cabling.

There are various digital data and video projection technologies in fixed installation and portable configurations available in the market place that compete on features, such as, brightness, weight, resolution, and compatibility.

There are 2 dominant technologies in digital projection: LCD and digital light processors (DLP). LCD projectors, as the name implies, use small transmissive LCD displays to create their digital images. These products typically operate as follows:

a) A projection lamp provides a white light source.

b) This light is split into the 3 primary colors (red, green, and blue).

c) The light for each color is projected through a grayscale LCD display that allows the appropriate portion of light for the desired image to pass through.

d) The 3 filtered colors are then optically recombined and projected for display.

Digital light processors are similar in concept optically, but of course different in their digital implementation. The filtering device is an array of digitally controlled micro-mirrors, constructed with micro-electro-mechanical (MEMs) semiconductor technology. These devices have an XY grid of very tiny mirrors and each mirror can be independently tilted under digital control in only 15 millionths of a second. Thus, a selective subset of the light source can be reflected under computer control to create an image. Grayscale is achieved by pulsing the mirrors at appropriate rates to pass the amount of light desired. Based upon a close cousin of pure semiconductor technology, DLPs are proving highly scalable in resolution.

For the purposes of this present invention description, “Digital Projector” shall be used as general terminology to describe a broad range of digital projection technologies including but not limited to LCD and DLP.

Synchronized Audio Visual Slide or Film Projection Devices

Today, slide or film projection systems require complex projectors and audio devices. Similar to digital projectors, these systems are relatively expensive and are typically used in business and institutional settings. As in the case of digital projectors, the complexity of the equipment requires a significant amount of set-up, which includes individual loading of the slides into the projector cartridge, film loading and coordination and audio synchronization. Setup normally requires one skilled and experienced in the operation of the equipment and may require a support person during operation.

Need for the Present Invention

The relative high price, physical complexity and hands-on set-up and operation of such equipment precludes its use as a child's toy to display a child's stories for a child's enjoyment; as a projection system for enjoyment by family's viewing picture and movie media; or by business, teachers or other professionals who need a self-contained, simple-to-operate, portable system for projecting sound and images/video onto a screen or surface such as a wall or ceiling. Likewise, a self-contained projection system with an integral digital media source would greatly simply the physical effort and technical requirements for business professional presentations by eliminating the need to transport and setup multiple hardware units, such as a laptop computer and projection device.

Prior Art

Tanaka et al., U.S. Pat. No. 5,461,437, present a Video Tape Recorder (VTR) equipped with an LCD projector integral therewith, capable of eliminating the complexity of wirings and preventing degradation of video signals. Tanaka, U.S. Pat. No. 5,729,395, present an updated instantiation of a Video Tape Recorder (VTR) with a liquid crystal display (LCD) projector free from a radiation blower. The VTR with LCD projector achieves compactness and reduction of cost, in keeping with the recent market trend.

Gussin et al., U.S. Pat. No. 5,266,980, present an audiovisual story-telling toy, which projects pictures on a surface such as a ceiling or a wall while a story recorded on an audiocassette is played. The toy is a small, self-contained unit, which includes a tape player and a synchronized picture strip projector. The toy includes an insertable, removable cartridge containing film with picture frames sequenced to correspond to the story on the tape.

Tanaka et al. have reduced the number of separate components, improved the overall wiring requirements, and reduced the total physical envelope dimensions by incorporating VTR and LCD technology into a self-contained projection system. Likewise, Gussin et al., have reduced the number of components and simplified the operation of slide or film projection with separate audio by introducing a synchronized audio-visual story-telling toy.

Although this prior art represents advancements in the development of less expensive, simplified, self-contained, audio-video projection systems, neither anticipates or provides for a combination of a Digital Media Source (internal and/or external), such as, a computer hard drive, digital disc player using Digital Versatile Disc (DVD), and/or Compact Disc (CD) format, and/or Compact Flash card, or any other non-volatile digital storage device; integral with a Microprocessor; an Image Projection Device, such as, a LCD or DLP based projector; and Audio Components to provide a stand alone system for use as a toy projection system, business projection system, or home projection system. An optional desktop rear projection screen and correction lens provides for the capability of desktop use or applications where no wall or ceiling is convenient, such as tradeshows.

### SUMMARY OF THE INVENTION

Therefore, an object of the invention is to solve the above mentioned problems encountered in the prior art and thus, to provide a combination of a Digital Media Source (internal and/or external), such as, a computer hard drive, digital disc player using Digital Video Disc (DVD), and/or Compact Disc (CD) format, and/or Compact Flash card, or any other nonvolatile; integral with a Microprocessor; an Image Projection Device, such as, a LCD or DLP based projector; a set of controls (with optional remote control), and audio components to provide a stand alone system for use as a toy projection system, business projection system, or home projection system

The present invention provides an Image Projection Device for projecting images onto a surface such as a wall or ceiling, or desktop rear projection screen using a projection lens configuration with a range of motion capable of achieving the necessary projection angle required to project an image on either a vertical or horizontal surface relative to the position of the projector. The present invention provides a Digital Media Source (internal and/or external), such as, a computer hard drive, digital disc player using Digital Versatile Disc (DVD), and/or Compact Disc (CD), and/or Compact Flash card, or any other non-volatile digital storage device format which provides the source digital signal to a microprocessor which decodes the data and sends the appropriate signals of the image and video data consistent with the input requirements for the Image Projection Device. The present invention provides an audio signal to a microprocessor which also sends the electrical signal to the amplifier which produces audio sound synchronized with the video or image through a single speaker or multiple speakers. The present invention provides for electrical power from either batteries, AC, DC, or a combination of power sources. The present invention provides a set of controls (with optional remote control) and a display to allow the user to advance or repeat the program material, or to begin the program material at a spot other than the beginning. For example, in the case of a child's story, the controls would allow skipping to specific chapters, repeating a chapter, or restarting at the beginning. In the case of a business presentation, the controls would allow the presenter to advance from one slide to the next, start or stop video, etc. In the case where a desktop rear projection screen is used, the image is inverted laterally to maintain the correct perspective.

In preferred embodiments, the system is enclosed in a housing that is configured to meet the market application. Thus, a system for children would have a housing that was configured like a character from traditional children's stories or popular culture or an object designed specifically to child's play. Likewise, a projection system for the home or professional applications would have a housing with an appearance and configuration similar to commercially available projection equipment. In preferred embodiments, the system will be easy to operate, self-contained, and portable and will be suitable for use by children and adults with minimal skill required. In preferred embodiments, the controls would be intuitive and easy to use, such as the standard set of controls common on CD players and videocassette recorders. In preferred embodiments the digital media source would use an industry standard format, such as the Enhanced CD format or the CD-I format, to provide audio and picture or video data.

Thus, it is an object of this invention to provide a self-contained synchronized toy projection system for children which would project digital image, data, and/or video media and play an audio recording of a story or lesson, both of which are contained on digital media, such as, a CD, DVD, computer hard drive, or other source and project it on a wall or ceiling surface, or optional desktop rear projection screen, via an integral Image Projection Device based on digital projection technology, such as, LCD, DLP or other.

It is another object of this invention to provide a self-contained synchronized professional projection system for home and institutional applications which would project digital image, data, and/or video media and optionally play an audio recording of a presentation or voice recording, both of which are contained on digital media, such as, a CD, DVD, computer hard drive, or other source and project it on a wall or ceiling surface, or optional desktop rear projection screen, via an integral Image Projection Device based on digital projection technology, such as, LCD, DLP or other.

It is another object of the present invention to provide a single, self-contained, less expensive projection system for the presentation of digital media.

It is another object of the present invention to provide a projection system with a range of motion capable of achieving the necessary projection angle required to project an image on either a vertical or horizontal surface relative to the position of the projector.

The above description as well as further objects, features and advantages of the present invention will be more fully understood by reference to the following detailed description of the presently preferred, illustrative embodiment in accordance with the present invention, when taken in conjunction with the accompanying drawings.

### DESCRIPTION OF DRAWINGS

A presently preferred embodiment of the disclosed invention is shown as described in connection with the accompanying drawings wherein:

FIG. 1 is a schematic view of an LCD projector.

FIG. 2 is a perspective view of a digital projector.

FIG. 3 is a schematic view of the disclosed invention.

FIG. 4 is a perspective view of a digital media source with portions thereof broken away to better disclose the structure.

FIG. 5 is a perspective view of the disclosed invention.

FIG. 6 is another perspective view of the disclosed invention.

FIG. 6A is yet another perspective view of the disclosed invention.

### DETAILED DESCRIPTION OF A PRESENTLY PREFERRED EMBODIMENT

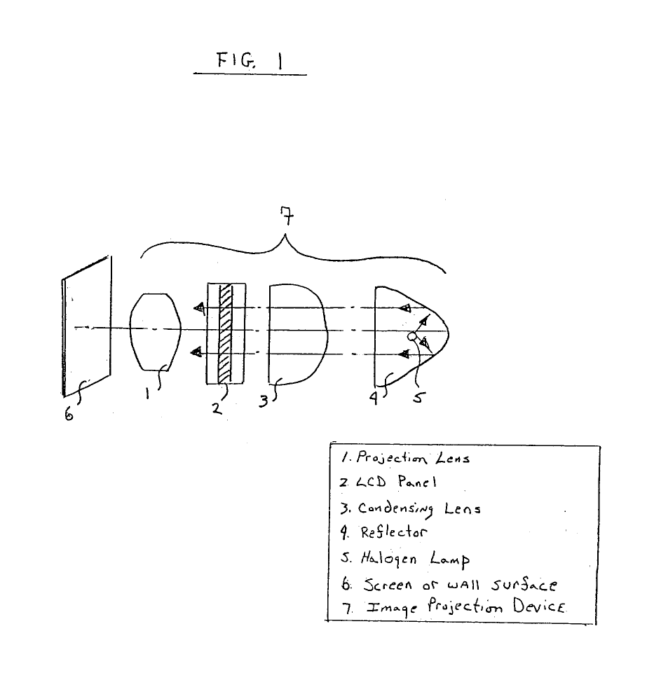

For illustration purposes regarding the potential configuration of a digital image projection device, FIG. 1 provides a schematic view of a LCD projector. As well known to those skilled in the art, a liquid crystal display projector (LCD) is an application of a liquid crystal display. In FIG. 1, the reference numeral 1 denotes a projection lens, 2 an LCD panel, 3 a condensing lens, 4 a reflector, 5 a halogen lamp, and 6 a screen such as a wall surface. In a typical LCD projector, light emerging from the halogen lamp 5 as a light source arranged in rear of the liquid crystal panel 2 is reflected by the reflector 4 and then introduced in the condensing lens 3 which, in turn, converts the received light into a parallel light. This light is applied on the back of an LCD panel 2. The pattern of light transmitted through the LCD panel is, thereafter, projected on a screen 6 by a projection lens 1, thus to produce a picture on the screen. Herein below, the component arrangement of items 1-5 shall be referred to simply as the “Image Projection Device” shown in FIG. 1 as reference numeral 7, and shall be used as general terminology to describe a broad range of digital projection configurations.

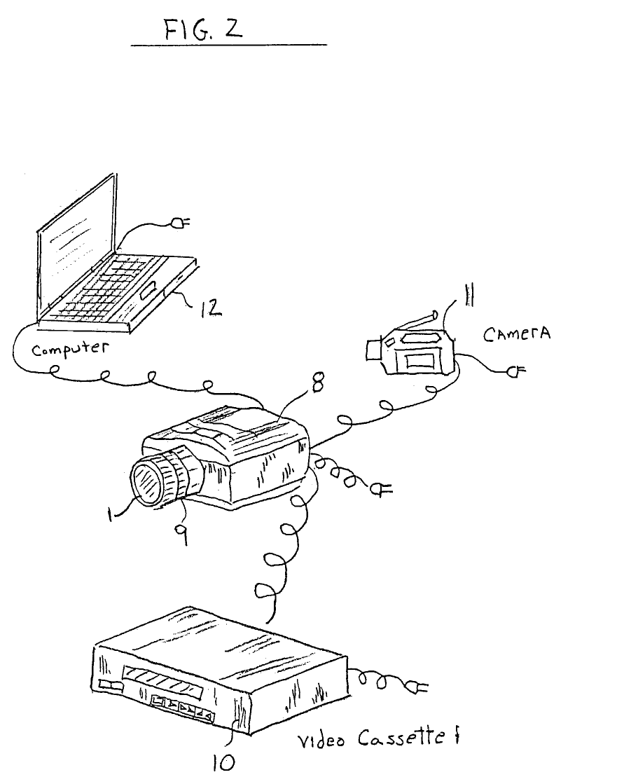

FIG. 2 is a perspective view of the appearance of the digital projector 8 including the internal arrangement of an image projection device 7. In FIG. 2., the reference numeral 1 denotes the projection lens shown in FIG. 1, 9 a focusing ring, 10 a video cassette recorder, 11 a video camera, 12 a laptop computer. The digital projector 8 of the illustrated type is commercially available in the form of a single product to be used exclusively for projection. As shown in FIG. 2, various wirings such as couplings, signal and power supply lines are connected between the digital projector 8 and the image/video/audio source devices 10, 11, 12.

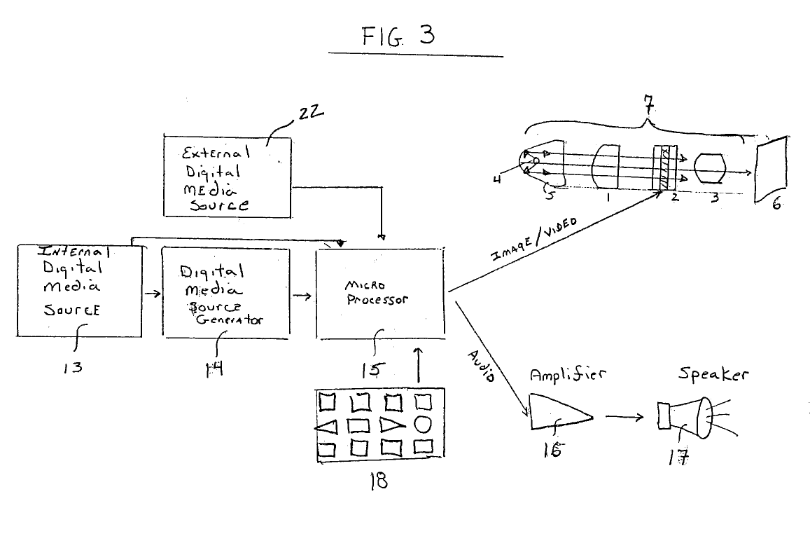

FIG. 3 is a schematic view explaining the basic concept of the present invention where an image generation device 7 (such as a LCD projector) is integral with a digital media source (hard drive and/or digital disc (i.e. Digital Video Disc (DVD), and/or Compact Disc (CD) format, or other) in a self-contained unit. In FIG. 3, reference numeral 13 denotes digital media source input (via technology like a hard drive, CD or DVD), 22 an external digital media source connected through cables, 14 a digital media source generator (via technology like a CD or DVD disc player, 15 a microprocessor, 16 a amplifier, 17 a speaker. As shown in FIG. 3, a digital signal stored on digital media 13 is sent to a microprocessor 15 using a digital source generator 14 such as a hard drive, CD or DVD disc player. The microprocessor 15 decodes the data from the Digital Media Source and extracts audio and video or still image data. The microprocessor 15 then sends the appropriate electrical signals to an image generation device 7, such as, but not limited to a LCD projector to display the video or still image data. The microprocessor 15 also sends the electrical signal to the amplifier 16 which produces audio sound synchronized with the video or image through the speaker(s) 17. Those skilled in the art will recognize that the decoding and signal generation functions performed by the microprocessor 15 could be replaced or augmented with application specific integrated circuits (ASICs) or other dedicated electronic circuitry. Those skilled in the art will also recognize that the microprocessor requires additional support functions, including but not limited to RAM, ROM, and signal driver circuitry. The microprocessor 15 monitors the set of controls 18 and sends the appropriate signals to the digital media source generator 14 so as to display the portion of the media requested by the user. As shown in FIG. 3 an internal digital media source 13 or external digital media source 22, such as, a computer hard drive may link directly to the microprocessor 15 and thus bypass the digital media source generator 14.

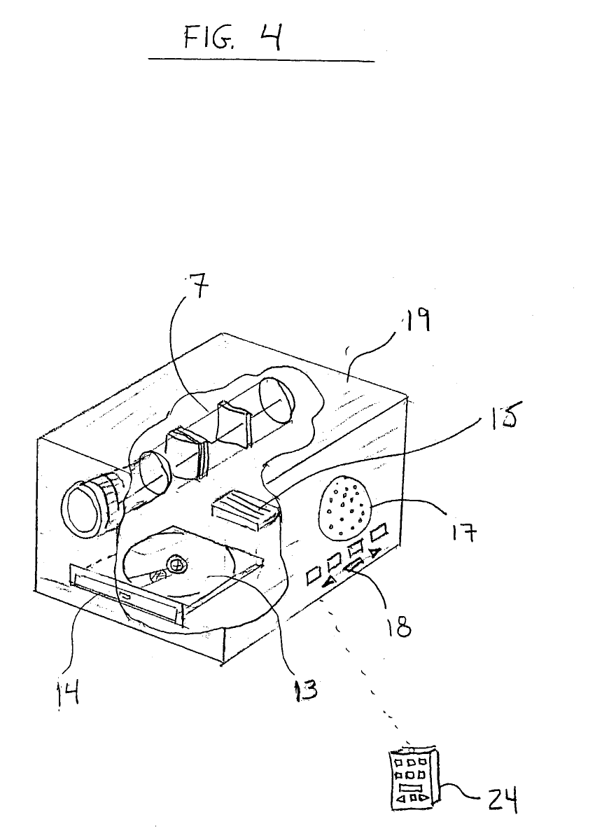

FIG. 4 is a partially-broken perspective view of a digital media source 13 with image generation device 7 in accordance with a general embodiment of the present invention. As shown in FIG. 4, reference numeral 13 denotes a digital media source (such as a computer hard drive, CD or DVD), 14 a digital media source generator such as a CD or DVD disc player (as shown schematically in FIG. 3), 15 a microprocessor (also as shown schematically in FIG. 3), and 17 a speaker. Also, shown in FIG. 4 is a general set of controls 18 on the exterior surface of the housing 19. Remote control 24 can also be included in the operation of the present invention.

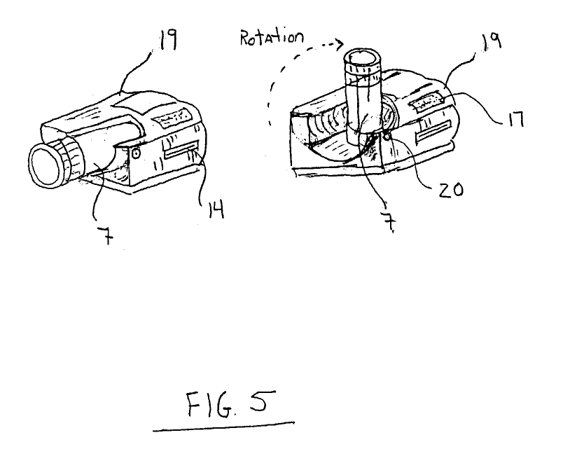

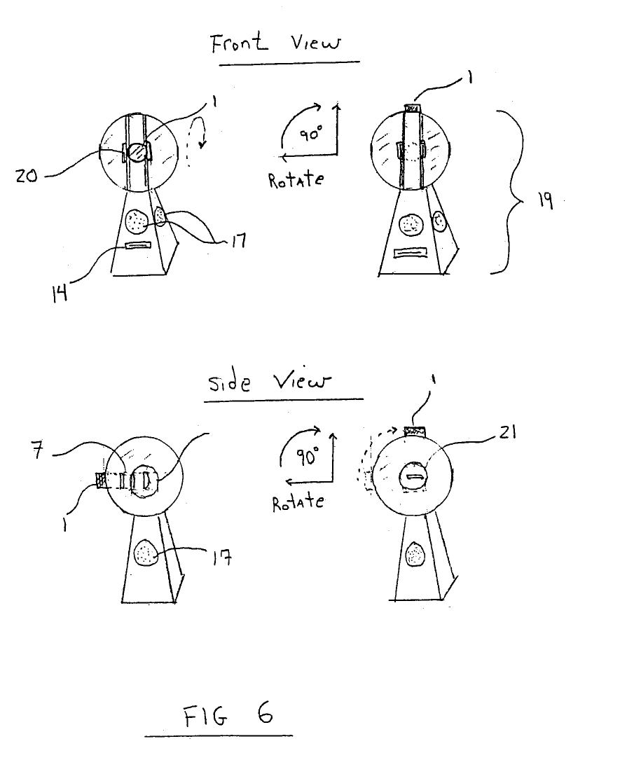

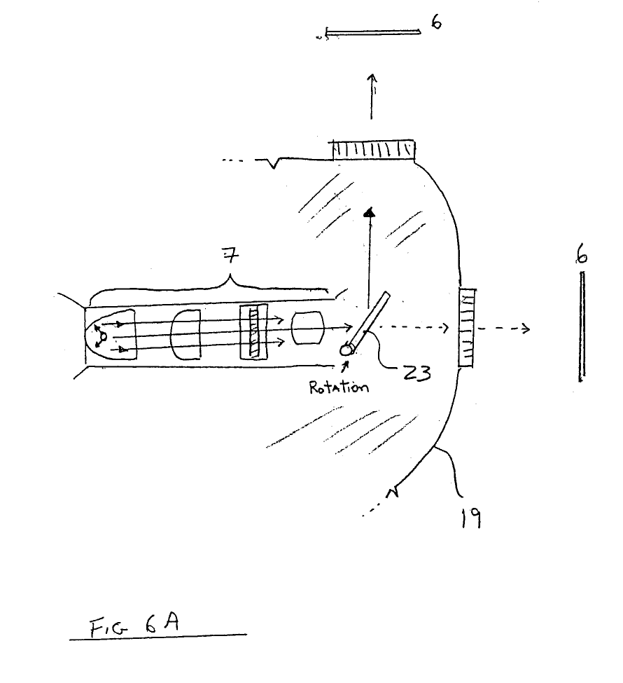

FIG. 5 is a perspective view of the present invention that shows the image generation device 7 positioned to project an image on a vertical surface with an optional rotational capability of approximately 90 degrees which accommodates the projection of an image on horizontal surface, such as, a ceiling. In the FIG. 5 general embodiment, the present invention is shown with a housing 19 represents an appearance package consistent with standard digital projectors found in the market place. As shown in FIG. 5, reference numeral 14 denotes a digital media source generator such as a CD or DVD disc player, 20 a mechanical/support interface which permits the image generation device 7 to rotate about an axis, and 17 speaker(s). Also, the image generation device 7 could be fixed within a housing 19, and a mirror 23 (refer to FIG. 6A) used to provide the rotational capability to project the image or video onto a horizontal or vertical surface 6. Thus, the configurations shown are provided as a general embodiment to convey the feature of image generation device rotation through various means.

FIG. 6 is a perspective view of the present invention that shows the image generation device 7 positioned to project an image on a vertical surface with a rotational capability of approximately 90 degrees which accommodates the projection of an image on horizontal surface, such as, a ceiling. In the FIG. 6 general embodiment, the present invention is shown with a housing 19 in a configuration more appropriate for a children's toy. It is anticipated that the housing 19 can be configured in the form of popular characters taking on the form of for example a bear, rabbit, dinosaur, etc. As shown in FIG. 6, reference numeral 14 denotes a digital media source generator such as a CD or DVD disc player, 20 a mechanical/support interface which permits the image generation device 7 to rotate about an axis, 21 denotes a mechanical component, such as, a knob or slot which allows the manual rotation of the image generation device 7, and 17 speaker(s). There are various other mechanical and optical design configurations that can be utilized to add the rotational functionality to the image generation device 7. For example, as in FIG. 6A, the image generation device 7 could be fixed within a housing 19, and a mirror 23 used to provide the rotational capability to project an image or video onto a horizontal or vertical surface 6. Thus, the configurations shown are provided as a general embodiment to convey the feature of image generation device 7 rotation through various means.

What is claimed is:

I claim:

1. A projection system comprising:
a digital non-volatile storage device that produces a source data signal;
a microprocessor that is connected to the digital non-volatile storage device said microprocessor generating an output projection signal in response to the source data signal of the digital non-volatile storage device;
an image projection device that is connected to said microprocessor, said image projection device providing an image display signal in response to the projection signal from said microprocessor;
a control set that is connected to said microprocessor, said control set being responsive to mechanical commands to provide control signals to said microprocessor, said microprocessor being responsive to said control rights to provide actuation signals to said digital non-volatile storage device, and said digital non-volatile storage device providing said source data signal in response to said actuation signals; and
a housing encompasses said digital non-volatile storage device, said microprocessor, said image projection device, and said control set.

2. The projection system of claim 1 wherein said microprocessor further provides an audio signal in response to said source data signal, said projection system further comprising:
an amplifier that is connected to said microprocessor and that is responsive to the audio signal of said microprocessor to provide a driver signal; and
a speaker that is connected to said amplifier, said speaker being responsive to the driver signal of said amplifier to produce audible sound.

3. The projection system of claim 1 or 2 wherein said digital non-volatile storage device comprises a computer hard drive.

4. The projection system of claims 1 or 2 wherein said digital non-volatile storage device comprising a digital disc player.

5. The projection system of claim 4 wherein said digital disc player uses a digital versatile/video disc format.

6. The projection system of claim 4 wherein said digital disc player uses compact disc format.

7. The projection system of claims 1 or 2 wherein said digital non-volatile storage device comprises a compact flash card.

8. The projection system of claims 1 or 2 wherein said image projection device includes a liquid crystal display.

9. The projection system of claim 1 or 2 wherein said image projection device includes a digital light processor.

10. The projection system of claim 1 or 2 wherein the image display signal of said image projection device is moveable over a range of angular positions.

11. The projection system of claim 10 wherein said range of angular positions is substantially 90 degrees.
